(19) United States
(12) Patent Application Publication
(10) Pub. No.: US 2025/0315999 A1
(43) Pub. Date: Oct. 9, 2025

(54) GROUP PORTRAIT PHOTO EDITING

(71) Applicant: ADOBE INC., SAN JOSE, CA (US)

(72) Inventors: Yuming Jiang, Singapore (SG); Nanxuan Zhao, San Jose, CA (US); Qing Liu, Santa Clara, CA (US); Krishna Kumar Singh, San Jose, CA (US)

(21) Appl. No.: 18/625,461

(22) Filed: Apr. 3, 2024

(51) Int. Cl. G06T 11/60; G06T 5/77

(52) U.S. Cl. CPC G06T 11/60; G06T 5/77

(57) ABSTRACT

A method, apparatus, non-transitory computer readable medium, and system for image generation includes obtaining an input image depicting an entity and a skeleton map depicting a pose of the entity and performing a cross-attention mechanism between image features of the input image and entity features representing the pose to obtain modified image features. An output image is generated based on the modified image features that depicts the entity with the pose.

### BACKGROUND

The following relates generally to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict information for an image in response to an input prompt, and to then generate the image based on the predicted information. In some cases, the prompt can be used to perform complex image manipulation and compositing. Such image generation provides for a user to edit an image and generate an image with desired features and therefore makes image generation easier for a layperson and also more readily automated.

### SUMMARY

Embodiments of the present disclosure provide an image processing system that includes an image generation model for diffusion based group portrait editing. According to an embodiment, the image generation model is configured to perform image inpainting for insertion or removal of an entity in an input image. In some cases, the image generation model modifies an interaction region between the entities based on a pose information, and uses a person-aware cross-attention module to preserve the content of an input image while modifying the pose.

A method, apparatus, and non-transitory computer readable medium for image processing are described. One or more aspects of the method, apparatus, and non-transitory computer readable medium include obtaining an input image depicting an entity and a skeleton map depicting a pose of the entity; performing, using an image generation model, a cross-attention mechanism between image features of the input image and entity features representing the pose to obtain modified image features; and generating, using the image generation model, an output image based on the modified image features, wherein the output image depicts the entity with the pose.

A method, apparatus, and non-transitory computer readable medium for image processing are described. One or more aspects of the method, apparatus, and non-transitory computer readable medium include obtaining a training set including a ground-truth image, a training input image, and a training skeleton map, wherein the ground-truth image includes a plurality of entities, wherein the training input image includes the plurality of entities and an obscured interaction region, and wherein the training skeleton map includes pose information for the plurality of entities; initializing the image generation model; and training, using the training set, the image generation model to generate an output image depicting an interaction between the plurality of entities based on the pose information.

An apparatus, system, and method for image processing are described. One or more aspects of the apparatus, system, and method include at least one processor; at least one memory component coupled with the at least one processor; and an image generation model comprising parameters stored in the at least one memory component and trained to receive an input image and pose information for a plurality of entities in the input image and to generate an output image depicting an interaction between the plurality of entities based on the pose information.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIG. 3 shows an example of an image generation process according to aspects of the present disclosure.

FIG. 4 shows an example of an image processing apparatus according to aspects of the present disclosure.

FIG. 5 shows an example of an image generation model according to aspects of the present disclosure.

FIG. 6 shows an example of a latent diffusion architecture according to aspects of the present disclosure.

FIG. 7 shows an example of an image processing method according to aspects of the present disclosure.

FIG. 8 shows an example of a method for training an image generation model according to aspects of the present disclosure.

FIG. 9 shows an example of a method for training a diffusion model according to aspects of the present disclosure.

FIG. 10 shows an example of a method for generation of training data according to aspects of the present disclosure.

FIG. 11 shows an example of a method for training an image generation model according to aspects of the present disclosure.

FIG. 12 shows an example of a computing device according to aspects of the present disclosure.

### DETAILED DESCRIPTION

Embodiments of the present disclosure provide an image processing system that includes an image generation model for diffusion based group portrait editing. According to an embodiment, the image generation model is configured to perform image inpainting for insertion or removal of an entity in an input image. In some cases, the image generation model modifies an interaction region between the entities based on a pose information, and uses a person-aware cross-attention module to preserve the content of an input image while modifying the pose.

Conventional image generation models are not able to produce modified images while preserving the content of the input image. In some examples, conventional image generation models may tend to generate images with an undesired pose information, or alter an interaction region between entities in the input image, or change an identity of an entity in the input image. Additionally, such models are not able to place an inserted entity in a specified location or adjust the lighting of the inserted entity to match a background of the input image.

Machine learning models are used to insert an object into an image and are thus useful for several image generation and editing applications. However, none of these methods address the task of group portrait editing, while particularly considering critical factors such as identity, interaction, background lighting, etc. to generate an image that depicts a reasonable interaction of the inserted entity with existing entities of the input image. Therefore, conventional image generation models do not consistently provide images where group editing is efficiently and consistently achieved.

Embodiments of the present disclosure include an image generation model that inpaints an image for insertion or removal of an entity (e.g., a person). Additionally, the image generation model modifies the interaction regions between the people in the image based on the insertion or removal and a pose information provided as input using a skeleton map. In some cases, the model includes a person-aware cross-attention module that enables preservation of content (i.e., details such as background, appearance or identity of entities, etc.) of the input image while modifying the pose. According to an embodiment, a diffusion model is used to generate a reposed output image with the desired interaction regions.

In some cases, the image generation system of the present disclosure takes a noisy image, a masked image, a binary mask, and a skeleton map as input. In some cases, the skeleton map is used to control the interaction between entities, for example, hand or arm position of people in an image. By using a skeleton map, embodiments of the present disclosure can guide the synthesis of the interaction region between two entities. That is, embodiments can modify the pose of the inserted entity and the existing entities for a natural-looking interaction based on the skeleton map that the users can manipulate. Similarly, embodiments can modify the pose of the existing entities in case of entity removal.

One or more embodiments of the present disclosure include a person-aware cross-attention module that preserves the appearance of entities after an image editing process. In some cases, the cross-attention module provides a specific location in the image for the entity to be inserted. In some examples, the module includes an indicator map to provide the accurate location of the inserted entity or an accurate location from which an entity is to be removed. In some cases, modified features from the cross-attention module are obtained based on a combination of the indicator map and the attention matrix. In some cases, an output image is generated based on the modified features.

Accordingly, by generating the output image using the image generation model, embodiments of the present disclosure provide a reposed image more efficiently and accurately than conventional image generation models. Further, in some cases, by providing the pose information based on the skeleton map, the image generation model provides for non-expert users (e.g., users without advanced Photoshop skills) to perform group portrait editing on an input image. Furthermore, in some cases, use of the person-aware cross-attention module enables preservation of the appearance (and location) of entities after the group editing process is complete.

In some cases, the image generation model is trained to generate a reposed image with a natural interaction between entities based on a training image, where the training image provides a plurality of entities and a masked interaction region. According to an embodiment, a training image is generated based on inpainting a large region of the input image for insertion/removal of an entity and further inpainting a small region of the input image for modifying an interaction region between entities. Thus, by training the image generation model based on the generated training image, embodiments of the present disclosure are able to generate images with more diverse interactions under different conditions than conventional image generation models.

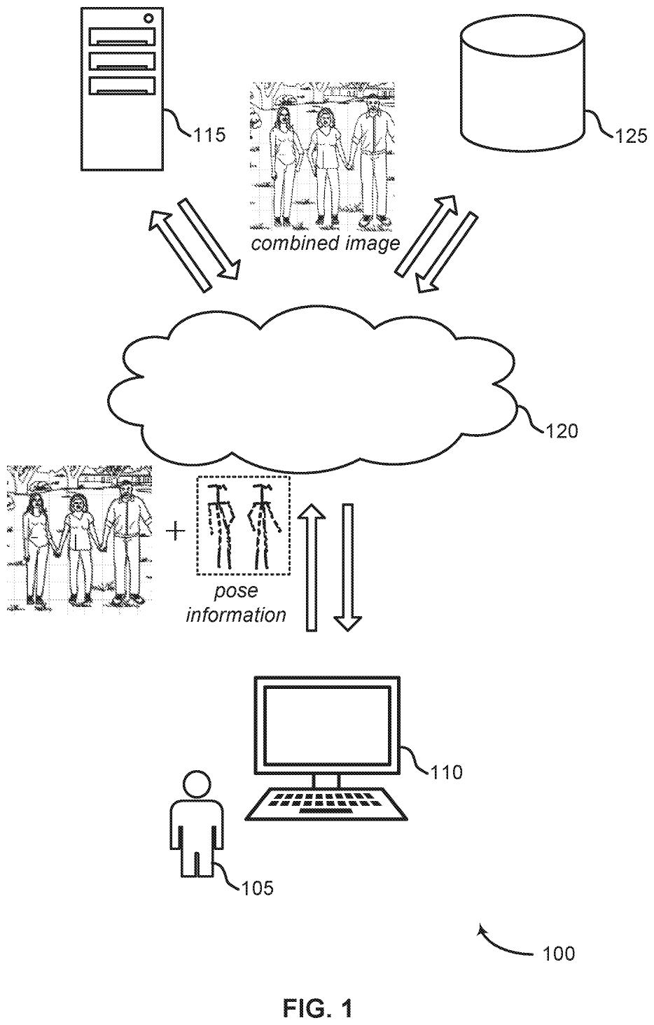

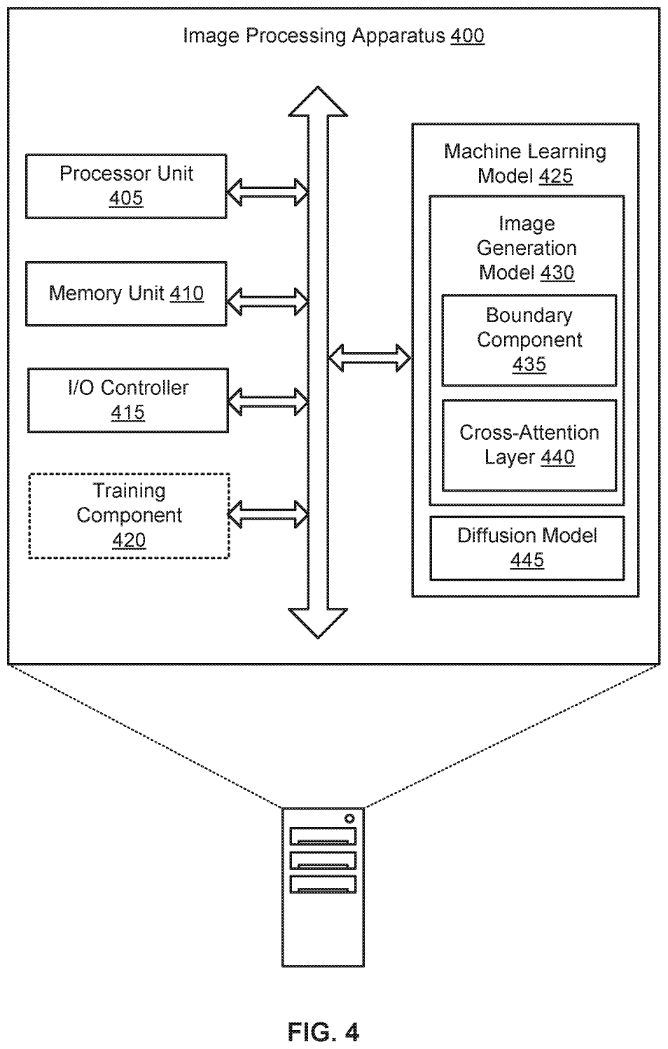

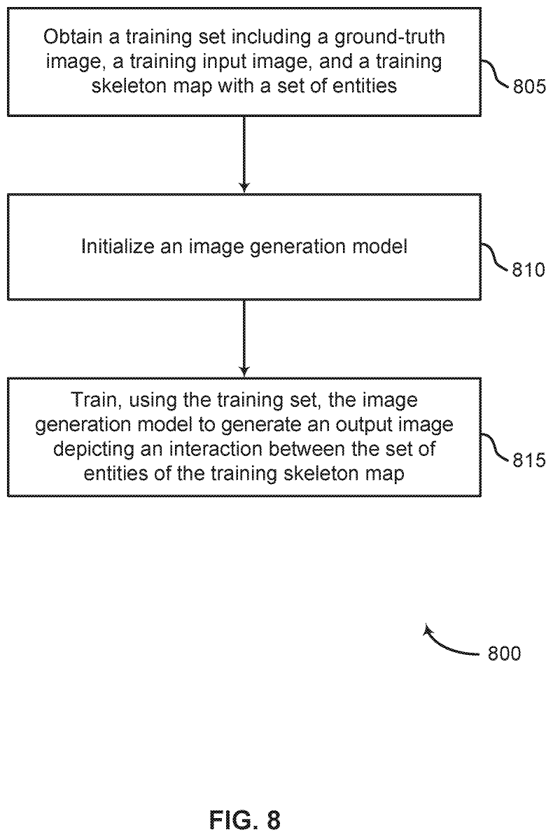

Embodiments of the present disclosure can be used in the context of image generation applications. For example, an image generation network based on the present disclosure takes an image and a pose information as input and efficiently generates a reposed image. Example applications regarding generating an image that depicts entities with desired pose and interactions are provided with reference to FIGS. 1-3 and 7. Details regarding the architecture of the image generation system are provided with reference to FIGS. 4-6 and 11. Examples of a process for training an image generation model are provided with reference to FIGS. 8-10.

Embodiments of the present disclosure include systems and methods that improve on conventional image generation models by more accurately depicting interactions between elements of the image. For example, embodiments of the disclosure generate images that insert or remove people from a group photo based on an inpainting task that inpaints the interaction regions. Embodiments achieve this improved accuracy by inpainting the interaction regions and using a skeleton map to guide an interaction between the people in the group after the insertion or removal. This enables users can to control the interaction regions while inserting or removing a person from the photo. An embodiment of the disclosure includes a person-aware appearance preservation module that uses a cross-attention mechanism to accurately and efficiently preserve the appearance of the entities (i.e., preserve the identity/appearance of a person) in the input image. By contrast, conventional image generation systems are not able to consistently generate images that can insert or remove a desired entity while maintaining accurate interaction areas between entities.

### Image Generation System

A system and an apparatus for image generation are described with reference to FIGS. 1-6 and 11. One or more aspects of the system and apparatus include at least one processor; at least one memory component coupled with the at least one processor; and an image generation model comprising parameters stored in the at least one memory component and trained to receive an input image and pose information for a plurality of entities in the input image and to generate an output image depicting an interaction between the plurality of entities based on the pose information. In some aspects, the image generation model comprises a boundary component configured to identify a bounding box for each of the entities.

In some aspects, the image generation model comprises a cross-attention layer configured to perform a cross-attention mechanism between image features of the input image and features representing the plurality of entities to obtain modified image features. In some aspects, the cross-attention layer is configured to compute a key vector and a value vector for each of the plurality of entities. In some aspects, the image generation model comprises a diffusion model. In some aspects, the image generation model comprises a U-net architecture.

FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user 105 provides an input image and pose information to image processing apparatus 115 via a user interface provided on user device 110 by image processing apparatus 115. As used herein, a “skeleton map” refers to an internal abstraction of a person's body depicting a simplified structure of the person's internal framework (e.g., bones). In some cases, the skeleton map may be a line drawing of the internal framework. As an example shown in FIG. 1, the user provides the skeleton map that depicts pose information of the person in the input image. In some cases, the skeleton map includes multiple persons (i.e., entities) and pose information for each of the entities. Additionally, in some cases, the pose information corresponds to an interaction between at least two of the persons (i.e., entities).

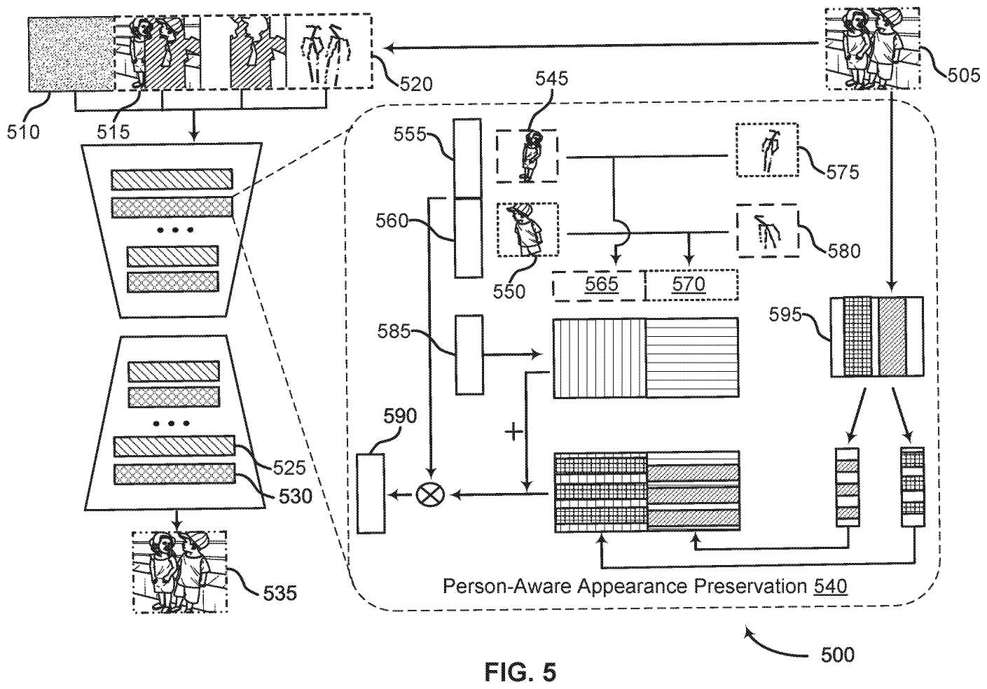

In some cases, the image processing apparatus 115 uses an image generation model (such as the image generation model described with reference to FIGS. 4-5) to generate an output image based on the input image and the skeleton map (i.e., pose information), such that the output image incorporates the pose information depicted in the skeleton map. In some cases, the image generation model is trained based on an input image (such as the process described with reference to FIGS. 8-10), such that the image generation model learns to generate images that include pose information provided by the skeleton map.

Referring to the example of FIG. 1, the image processing apparatus 115 provides the output image to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface allows information (such as an image, a prompt, user inputs, etc.) to be communicated between user 105 and image processing apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

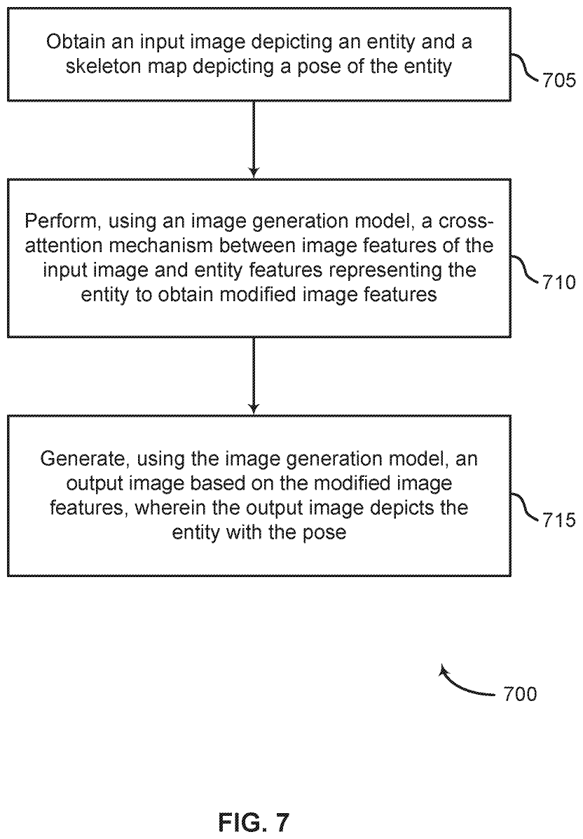

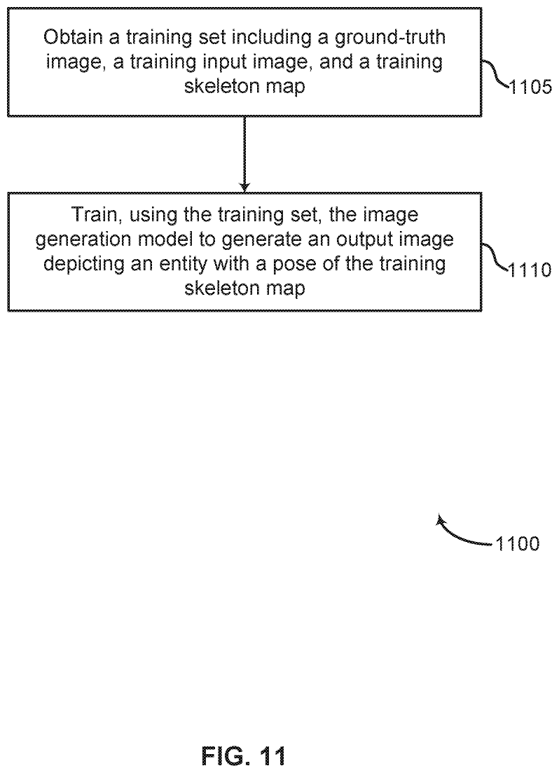

Image processing apparatus 115 is an example of, or includes aspects of, the corresponding element described with reference to FIG. 4. According to some aspects, image processing apparatus 115 includes a computer-implemented network. In some embodiments, the computer-implemented network includes a machine learning model (such as the image generation model described with reference to FIGS. 5 and 7). In some embodiments, image processing apparatus 115 also includes one or more processors, a memory subsystem, a communication interface, an I/O interface, one or more user interface components, and a bus as described with reference to FIG. 11. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

According to some aspects, image processing apparatus 115 obtains an input image and a skeleton map, where the input image depicts a first entity, a second entity, and a third entity, and where the skeleton map indicates a first pose of the first entity and a second pose of the second entity. For example, the first pose and the second pose in the skeleton map are different from the pose of the input image. In some examples, image processing apparatus 115 obtains an inpainting mask indicating an interaction region for the first entity and the second entity, where the output image is generated based on the inpainting mask.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

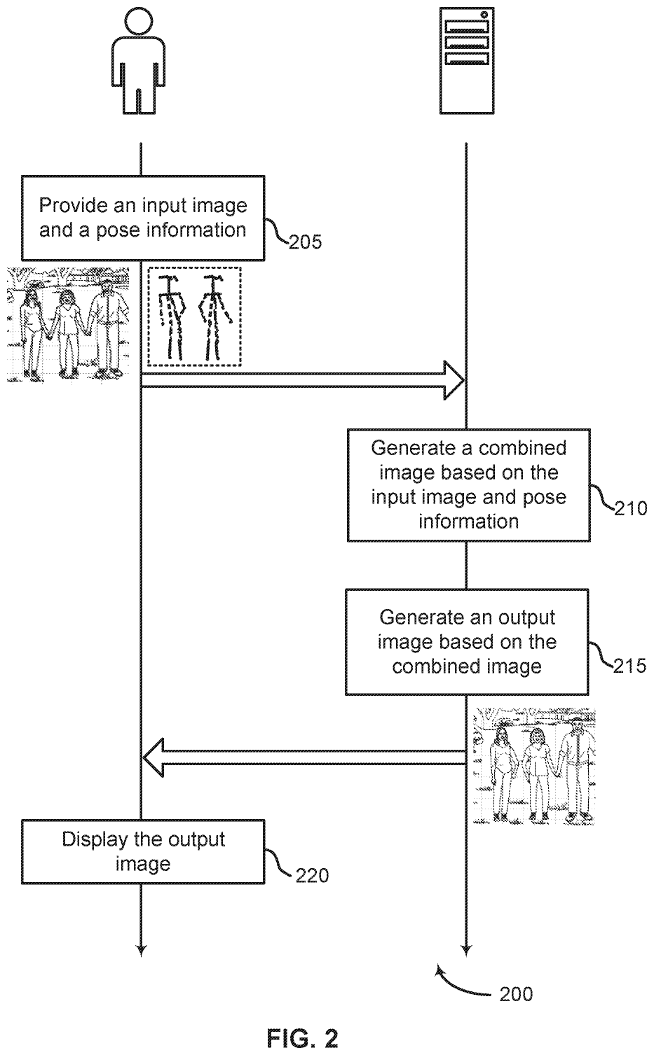

FIG. 2 shows an example of a method 200 for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

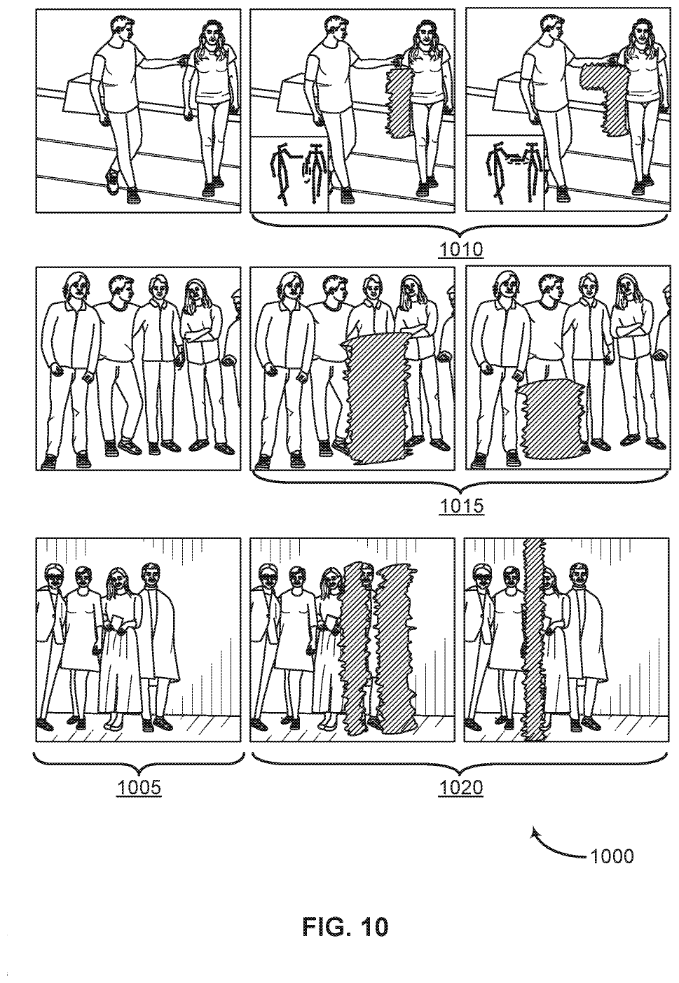

According to an embodiment of the present disclosure, an image processing apparatus (such as the image processing apparatus described with reference to FIG. 4) provides an image generation model (such as the image generation model described with reference to FIGS. 5 and 7) that is trained based on a training image generated based on inpainting a portion of the image (using a process described with reference to FIG. 10) to generate an image depicting entities with desired pose information.

At operation 205, a user (such as the user described with reference to FIG. 1) provides an input image and pose information. For example, the user provides the input image and the pose information to the image processing apparatus (such as the image processing apparatus described with reference to FIG. 1). As shown in FIG. 2, the skeleton map depicts a line drawing of the pose information of the entities. In some cases, the skeleton map includes multiple entities and pose information for each of the entities. Additionally, in some cases, the pose information corresponds to an interaction between at least two of the entities. In some cases, the user provides the skeleton map and the input image to the image processing apparatus via a user interface (such as a graphical user interface) provided on a user device by the image processing apparatus.

At operation 210, the system generates a combined image based on the input image and the pose information using the image generation model, where the image generation model is conditioned using a generated training image. For example, the combined image may refer to an image that incorporates the pose information of the skeleton map into the input image. In some cases, the operations of this step refer to, or may be performed by, an image processing apparatus as described with reference to FIG. 4.

At operation 215, the system generates an output image based on the combined image. As shown in FIG. 2, the generated output image modifies the position of hands of two entities. For example, the position of hands of the two entities in the generated output image matches that in the user-provided skeleton map. In some cases, the operations of this step refer to, or may be performed by, an image processing apparatus as described with reference to FIG. 4.

At operation 220, the system displays the output image to the user. In some cases, the operations of this step refer to, or may be performed by, an image processing apparatus as described with reference to FIG. 4. For example, in some cases, the image processing apparatus displays the output image to the user via the user interface.

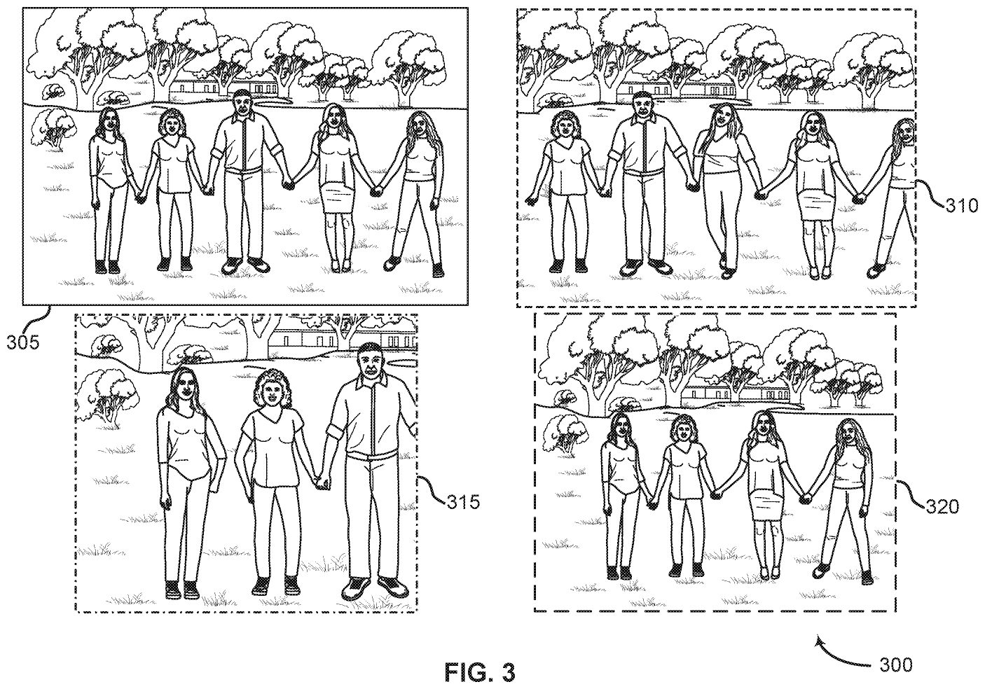

FIG. 3 shows an example of an image editing process 300 according to aspects of the present disclosure. In one aspect, image editing process 300 includes input image 305, first output image 310, second output image 315, and third output image 320. Input image 305 is an example of, or includes aspects of, the corresponding element described with reference to FIG. 5.

Referring to FIG. 3, each of the first output image 310, second output image 315, and third output image 320 are images that are generated based on a modification to input image 305. In some cases, first output image 310 is generated by inserting an entity in the input image 305. For example, first output image 310 depicts an additional entity (i.e., a new woman next to a man in the input image 305). In some examples, the incorporation of the additional entity is performed such that the background or lighting of the additional entity matches that of the input image 305. Additionally, the first output image 310 illustrates a natural-looking pose of the existing entities and the additional entity (i.e., each entity is holding a hand of the neighboring entity) while maintaining the identity of the additional and existing entities.

In some cases, second output image 315 is generated by modifying a pose of an entity in the input image 305. For example, input image 305 depicts each entity as holding hands. In some examples, second output image 315 depicts a reposed image. For example, the reposed image i.e., second output image 315, depicts a hand position of two entities that is different than input image 305.

In some cases, third output image 320 is generated by removing an entity from the input image 305. For example, third output image 320 depicts an image (i.e., with a man removed from the input image 305). In some examples, the removal of an existing entity is performed such that an output image (e.g., third output image 320) provided includes a reasonable pose such as that of the input image 305 (e.g., based on an adjustment to the poses of the remaining entities in input image 305). The third output image 320 illustrates a natural-looking pose of the remaining entities, i.e., women on either side of the man are now holding hands.

FIG. 4 shows an example of an image processing apparatus 400 according to aspects of the present disclosure. In one aspect, an image processing apparatus 400 includes processor unit 405, memory unit 410, I/O controller 415, training component 420, and machine learning model 425.

Processor unit 405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 405 is configured to operate a memory array using a memory controller. In other cases, a memory controller is integrated into processor unit 405. In some cases, processor unit 405 is configured to execute computer-readable instructions stored in memory unit 410 to perform various functions. In some aspects, processor unit 405 includes special purpose components for modem processing, baseband processing, digital signal processing, or transmission processing. According to some aspects, processor unit 405 comprises the one or more processors described with reference to FIG. 11.

Memory unit 410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 705 to perform various functions described herein.

In some cases, memory unit 410 includes a basic input/output system (BIOS) that controls basic hardware or software operations, such as an interaction with peripheral components or devices. In some cases, memory unit 410 includes a memory controller that operates memory cells of memory unit 410. For example, the memory controller may include a row decoder, column decoder, or both. In some cases, memory cells within memory unit 410 store information in the form of a logical state. According to some aspects, memory unit 410 comprises the memory subsystem described with reference to FIG. 11.

I/O controller 415 may manage input and output signals for a device. I/O controller 415 may also manage peripherals not integrated into a device. In some cases, an I/O controller 415 may represent a physical connection or port to an external peripheral. In some cases, an I/O controller 415 may utilize an operating system such as iOS®, ANDROID®, MS-DOS®, MS-WINDOWS®, OS/2®, UNIX®, LINUX®, or another known operating system. In other cases, an I/O controller 415 may represent or interact with a modem, a keyboard, a mouse, a touchscreen, or a similar device. In some cases, an I/O controller 415 may be implemented as part of a processor. In some cases, a user may interact with a device via I/O controller 415 or via hardware components controlled by an I/O controller 415.

In some examples, I/O controller 415 includes a user interface. A user interface may enable a user to interact with a device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

Machine learning model 425 is an example of, or includes aspects of, the corresponding element described with reference to FIG. 5. According to some aspects, machine learning model 425 is implemented as software stored in memory unit 410 and executable by processor unit 405, as firmware, as one or more hardware circuits, or as a combination thereof. According to some aspects, machine learning model 425 comprises image generation model 430 stored in memory unit 410.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data. Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, that control a degree of connections between neurons and influence the neural network's ability to capture complex patterns in data. An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, machine learning model 425 obtains a training set including a ground-truth image, a training input image, and a training skeleton map, where the ground-truth image includes a plurality of entities, where the training input image includes the plurality of entities and an obscured interaction region, and where the training skeleton map includes pose information for the plurality of entities. In some examples, machine learning model 425 initializes an image generation model 430.

In some examples, machine learning model 425 obtains the training set and includes obscuring a portion of the ground-truth image corresponding to the obscured interaction region to obtain the training input image. In some examples, machine learning model 425 obtains the training set and includes computing the training skeleton map based on the ground-truth image. In some examples, machine learning model 425 trains the image generation model 430 and includes computing a diffusion loss.

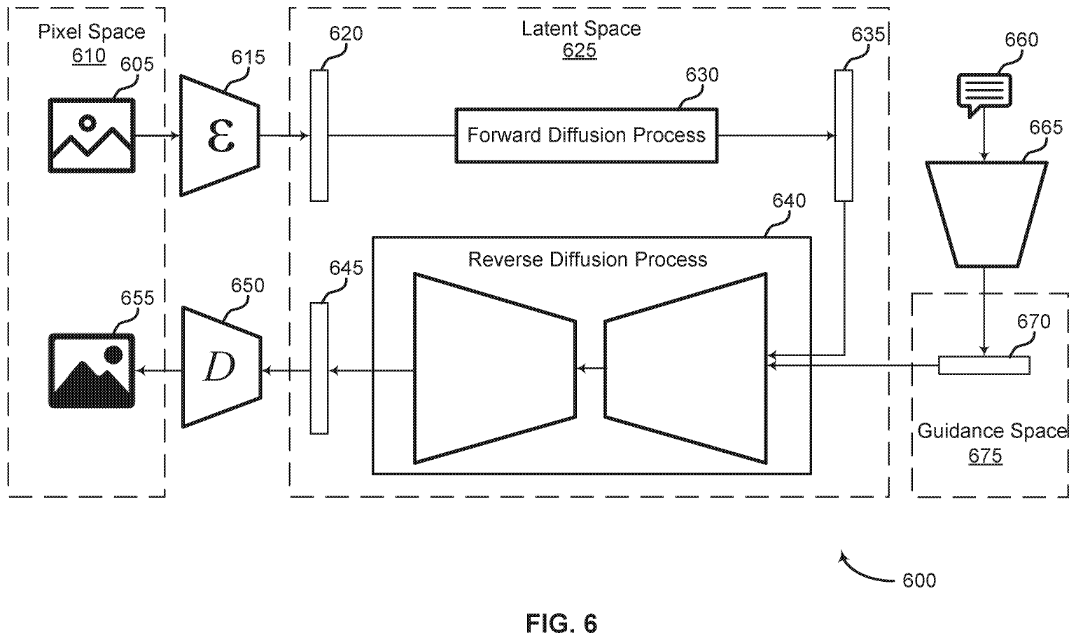

In one aspect, machine learning model 425 includes image generation model 430 and diffusion model 445. According to some aspects, the diffusion model implements a reverse diffusion process (such as the reverse diffusion process described with reference to FIG. 6). In some cases, image generation model 430 includes a U-Net.

Image generation model 430 is an example of, or includes aspects of, the corresponding element described with reference to FIGS. 5 and 7. According to some aspects, image generation model 430 is implemented as software stored in memory unit 410 and executable by processor unit 405, as firmware, as one or more hardware circuits, or as a combination thereof.

According to some aspects, image generation model 430 performs a cross-attention mechanism between image features of the input image and entity features representing the pose to obtain modified image features. In some examples, image generation model 430 generates an output image based on the modified image features, where the output image depicts the entity with the pose. In some cases, the pose includes an interaction between at least two of the entities. In some examples, image generation model 430 obtains the input image which further includes obtaining a first preliminary image depicting the entity and a second preliminary image depicting an additional entity. In some examples, image generation model 430 combines the first preliminary image and the second preliminary image to obtain the input image.

In some examples, image generation model 430 encodes the input image to obtain the image features. In some examples, image generation model 430 encodes a first region of the input image surrounding the entity to obtain the entity features. In some examples, image generation model 430 encodes a second region of the input image surrounding the second entity to obtain the features representing the second entity.

According to some aspects, image generation model 430 comprises parameters stored in the at least one memory component and trained to receive an input image and pose information for a plurality of entities in the input image and to generate an output image depicting an interaction between the plurality of entities based on the pose information. In some aspects, the image generation model 430 includes a diffusion model 445 (such as a diffusion model described with reference to FIG. 6). In some aspects, the image generation model 430 includes a U-net architecture.

In some aspects, the image generation model 430 is trained using a training set including a training image and a training skeleton map, where the training image includes a plurality of entities and an obscured interaction region between the plurality of entities, and where the training skeleton map includes pose information for the plurality of entities.

In one aspect, image generation model 430 includes boundary component 435 and cross-attention layer 440. According to some aspects, boundary component 435 identifies a first bounding box for the entity and a second bounding box for the additional entity, where the first region is based on the first bounding box. In some aspects, the image generation model 430 includes a boundary component 435 configured to identify a bounding box for each of the entities.

In the machine learning field, an attention mechanism is a method of placing differing levels of importance on different elements of an input. Some sequence models process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

In some cases, an ANN employing an attention mechanism receives an input sequence and maintains its current state, which represents an understanding or context. For each element in the input sequence, the attention mechanism computes an attention score that indicates the importance or relevance of that element given the current state. The attention scores are transformed into attention weights through a normalization process (e.g., applying a softmax function). The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

In some cases, by incorporating an attention mechanism, an ANN dynamically allocates attention to different parts of the input sequence, allowing the ANN to focus on relevant information and capture dependencies across longer distances.

In some cases, calculating attention involves three basic steps. First, a similarity between a query vector Q and a key vector K obtained from the input is computed to generate attention weights. In some cases, similarity functions used for this process include dot product, splice, detector, and the like. Next, a softmax function is used to normalize the attention weights. Finally, the attention weights are weighed together with their corresponding values V. In the context of an attention network, the key K and value V are typically vectors or matrices that are used to represent the input data. The key K is used to determine which parts of the input the attention mechanism should focus on, while the value V is used to represent the actual data being processed.

In some cases, an attention mechanism may refer to a self-attention mechanism and/or a cross-attention mechanism. A self-attention mechanism enables a network to weigh input elements selectively (e.g., based on a relevance to other elements), emphasizing important features during computation. The self-attention mechanism incorporates dynamic attention scores, optimizing information processing. Additionally, a cross-attention mechanism facilitates effective interaction between different input sequences in neural network architectures by dynamically assigning attention scores based on their relevance. The cross-attention mechanism enhances model performance by providing for the network to focus on key features from one sequence while processing another, enabling more nuanced and context-aware information processing.

According to some aspects, cross-attention layer 440 performs the cross-attention mechanism includes computing a key vector and a value vector for each of the first entity and the second entity. In some aspects, the image generation model 430 includes a cross-attention layer 440 configured to perform a cross-attention mechanism between image features of the input image and features representing the set of entities to obtain modified image features. In some aspects, the cross-attention layer 440 is configured to compute a key vector and a value vector for each of the set of entities. Cross-attention layer 440 is an example of, or includes aspects of, the corresponding element described with reference to FIG. 5.

According to some aspects, diffusion model 445 generates the output image and includes obtaining a noisy image. In some examples, diffusion model 445 performs a reverse diffusion process on the noisy image to obtain the output image. According to some aspects, diffusion model 445 trains the image generation model 430 includes obtaining a noisy image. In some examples, diffusion model 445 performs a reverse diffusion process on the noisy image. Diffusion model 445 is an example of, or includes aspects of, the corresponding element described with reference to FIG. 6.

According to some aspects, training component 420 is implemented as software stored in memory unit 410 and executable by processor unit 405, as firmware, as one or more hardware circuits, or as a combination thereof. According to some aspects, training component 420 is omitted from image processing apparatus 400. According to some aspects, training component 420 is implemented as software stored in memory and executable by a processor of an external apparatus, as firmware of the external apparatus, as one or more hardware circuits of the external apparatus, or as a combination thereof, and communicates with image processing apparatus 400 to perform the functions described herein.

According to some aspects, training component 420 trains, using the training set, the image generation model 430 to generate an output image depicting an interaction between the set of entities based on the pose information. In some examples, training component 420 updates parameters of the image generation model 430 based on the diffusion loss.

Embodiments of the present disclosure are configured to be implemented in a group portrait editing process. In some cases, the interaction regions (or pose information) and the missing portions (or missing body parts) are inpainted when inserting an entity (e.g., a person) in an image. In some examples, the interaction regions (or a removed body part) are inpainted if an entity removed from an image is holding hands.

According to an embodiment, a skeleton map is used as an additional condition to guide the synthesis of an interaction region. For example, in case of person addition or insertion, a pose of an inserted person and a neighboring person(s) is manipulated to ensure a natural interaction between the inserted person and the neighboring person(s). For example, in case of person removal, a pose of the existing person(s) is manipulated to ensure a natural pose and interaction.

FIG. 5 shows an example of an image generation model 500 according to aspects of the present disclosure. In one aspect, an image generation model 500 includes input image 505, noise image 510, masked image 515, skeleton map 520, self-attention layer 525, cross-attention layer 530, output image 535, and person-aware appearance preservation 540.

Referring to FIG. 5, input image 505 is obtained from a user (such as a user described with reference to FIG. 1), or a database (such as a database described with reference to FIG. 1) via a user interface of a user device (as described with reference to FIG. 1). Input image 505 is an example of, or includes aspects of, the corresponding element described with reference to FIG. 3.

Training component (such as a training component described with reference to FIG. 4) is used to generate paired data based on a training data generation process. For example, the generated paired data is provided as input for the diffusion model to generate output image 535. In some examples, the diffusion model takes a noise image 510, masked image 515, and a binary masked image as input. Additionally, in some cases, the diffusion model takes a skeleton map 520 (i.e., a target skeleton map) as input. Masked image 515 is an example of, or includes aspects of, the corresponding element described with reference to FIG. 10. Skeleton map 520 is an example of, or includes aspects of, the corresponding element described with reference to FIGS. 1-2, 7, and 10. Further details regarding generation of paired data based on input image using training component are provided with reference to FIG. 10.

Diffusion models generate images by iterative denoising from a noise map, which is normally sampled from the Gaussian distribution. In some cases, diffusion models use a variational autoencoder (VAE) to project the image from pixel space to latent space. In some cases, the model can synthesize high-resolution images based on downscaled latent representations. In some cases, θ is parameterized as a UNet (details of the diffusion process are provided with reference to FIG. 6) with multiple self-attention modules and cross-attention modules. In each block, a self-attention module is followed by a cross-attention module. In the cross-attention module, the features f are updated as:

$$f = softmax ( \frac{{KQ}^{T}}{\sqrt{d}} ) \cdot V , \\ K = {ϕ}_{K} ( {f}_{t} ) , V = ϕ {L}_{V} ( {f}_{t} ) , Q = {ϕ}_{Q} ( f ) \qquad ( 1 )$$

where fₜ is the text embedding, ϕ_{K} and ϕ_{Q} are the linear layers to project the features into keys, values, and queries, respectively. Further details regarding generation of output image based on an input image using a diffusion process are provided with reference to FIG. 6.

In some cases, the inputs (i.e., noise image 510, masked image 515, a binary masked image, and skeleton map 520) are concatenated together before providing as input to the diffusion model. For example, the masked region is filled with gray color. In some examples, the skeleton map provides an option to the user to specify the desired human interaction (e.g., inter-personal interaction). In some cases, the skeleton map includes multiple persons (i.e., entities) and pose information for each of the entities. Additionally, in some cases, the pose information corresponds to an interaction between at least two of the persons (i.e., entities).

According to an embodiment, diffusion model includes self-attention layer 525 and cross-attention layer 530. In some cases, diffusion model is an example of, or includes aspects of, the diffusion model described with reference to FIG. 6. For example, in some cases, the diffusion model includes a self-attention block comprising one or more self-attention layers (such as self-attention layer 525), a cross-attention block comprising one or more cross-attention layers (such as cross-attention layer 530), or a combination thereof to further increase the capacity of image generation model 500. Self-attention layer 525 is an example of, or includes aspects of, the corresponding element described with reference to FIG. 4. Cross-attention layer 530 is an example of, or includes aspects of, the corresponding element described with reference to FIG. 4.

An embodiment of the present disclosure includes person-aware appearance preservation configured to provide inter-person guidance to generate an output image based on a cross-attention mechanism. In some cases, a masked region covers the area that the user wants unaltered after editing (such as clothing, skin color, identity information, etc.). Accordingly, an embodiment of the disclosure takes the reference images of each entity as a model condition. For example, each reference entity (e.g., person) is provided as a separate image. In some cases, the reference images refer to an inserted entity or a neighboring entity around an interaction region. In some cases, the reference image is input to person-aware appearance preservation 540 based on a cross-attention mechanism. By providing a reference image to the person-aware appearance preservation, embodiments of the present disclosure enable the image generation model to maintain or preserve the appearance details after completion of group portrait editing.

According to an embodiment, each reference image is input to cross-attention layer 530 of the plurality of cross-attention layers in the diffusion model. In some examples, the reference images are obtained based on segmenting the person(s) covered by the mask during the training process. In some examples, the reference images are obtained based on filling the background (e.g., providing a white background). The reference images are input to each cross-attention layer 530 using person-aware appearance preservation 540.

In one aspect, person-aware appearance preservation 540 includes first reference image 545, second reference image 550, first value embedding 555, second value embedding 560, first key embedding 565, second key embedding 570, first skeleton map 575, second skeleton map 580, query embedding 585, and modified image features 590.

In some cases, each reference image is encoded (e.g., using a pre-trained model) into a feature embedding f_{I}_{ᵢ}∈ [symbol] ^{256×768}. Next, based on a cross-attention operation, a value embedding V∈ [symbol] ^{(256·N)×d} and key embedding K∈ [symbol] ^{(256·N)×d} are obtained through linear layers after concatenating the features as F=[f_{I}_{₁},f_{I}_{₂} . . . , f_{I}_{_{N}}]. As shown in FIG. 5, first reference image 545 and second reference image 550 are used to generate first value embedding 555 and second value embedding 560 corresponding to each of the first reference image 545 and second reference image 550, respectively.

An output feature (O) is generated based on the value embedding and the key embedding:

$$O = softmax ( \frac{{KQ}^{T}}{\sqrt{d}} ) \cdot V , \\ K = {ϕ}_{K} ( F ) , V = {ϕ}_{V} ( F ) \qquad ( 2 )$$

wherein d denotes feature dimension, and the query embedding Q∈ [symbol] ^{HW×d} is determined based on an output of self-attention layer 525. As used herein, H and W refer to the spatial resolution of the features from the previous layer (e.g., self-attention layer 525).

An embodiment of the present disclosure includes an intra-person guidance and an inter-person guidance. In some cases, for the intra-person guidance, the image generation model learns the correspondence between pixel appearances with the body components for each reference image. Accordingly, in some cases, the model can adaptively learn the mapping to restore accurate appearances.

In some cases, the skeleton pose P_{I}_{ᵢ} of the exemplar images I_{I} is used as an intra-person indicator. Additionally, a separately learned encoder is used to extract pose features p_{I}_{ᵢ}. In some cases, the key embedding after concatenating the image and pose features is computed:

$$\hat{K} = {ϕ}_{K} ( [ {K}_{1} , {K}_{2} , … , {K}_{N} ] ) , \\ {K}_{N} = MLP ( [ {f}_{{I}_{k}} , {p}_{{I}_{k}} ] ) \qquad ( 3 )$$

where [·] refers to the concatenation operation and MLP(·) refers to layers to process the concatenated features. Referring to FIG. 5, first key embedding 565 and second key embedding 570 are generated based on the concatenation.

In some cases, for the inter-person guidance, the person-aware appearance preservation 540 of the image generation model 500 includes an indicator mask to specify a location of each entity. For example, the indicator mask specifies a location of the first reference image 545 and second reference image 550. The indicator mask 595 is obtained by bounding boxes around each entity (e.g., first reference image 545 and second reference image 550). The bounding boxes completely cover the reference images, for example, the bounding boxes cover the complete body in first reference image 545 and second reference image 550.

In some cases, the corresponding indicator masks are reshaping into flattened tensors and repeated to form an indicator matrix M_{Ind} for each reference image. The indicator matrix shares the same dimension with each attention matrix M_{Attn}∈ [symbol] ^{H·W+256·N}. For example, an indicator matrix with the same dimension as attention matrix is formed for each of first reference image 545 and second reference image 550. In some cases, the attention matrix is obtained:

$${M}_{Attn} = \hat{K} {Q}^{T} \qquad ( 4 )$$

The indicator matrix is added to the attention matrix before applying the softmax operation. As a result, when calculating the final output (e.g., modified image features 590), the corresponding location includes higher weights to attend to the correct reference features. The operation is computed as:

$$O = softmax ( \frac{{M}_{Attn} + {M}_{Indicator}}{\sqrt{d}} ) \cdot V \qquad ( 5 )$$

where the V refers to first value embedding 555 or second value embedding 560. In some cases, each of first value embedding 555 or second value embedding 560 is used to ensure accurate appearance features. In some cases, the indicator matrix is multiplied by a scale factor obtained as:

$${w}^{′} = w \cdot log ( 1 + σ ) \cdot max ( {M}_{Attn} ) , \qquad ( 6 )$$

where w is the scale factor, and o corresponds to the noise level at different diffusion steps.

In some cases, the modified image features 590 are obtained based on the first value embedding 555, second value embedding 560, and by incorporating the indicator matrix into the attention matrix. The output image 535 is obtained based on the modified image features 590 using the diffusion process.

FIG. 6 shows an example of a latent diffusion architecture 600 according to aspects of the present disclosure. Diffusion models are a class of generative ANNs that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that a same input results in a same output. Diffusion models may also be characterized by whether noise is added to an image itself, or to image features generated by an encoder, as in latent diffusion.

For example, according to some aspects, image encoder 615 encodes original image 605 from pixel space 610 and generates original image features 620 in latent space 625. In some cases, original image 605 is an example of, or includes aspects of, a training image described with reference to FIG. 10. In some cases, image encoder 615 covers an image structure and semantic concepts of original image 605.

According to some aspects, forward diffusion process 630 gradually adds noise to original image features 620 to obtain noisy features 635 (also in latent space 625) at various noise levels. In some cases, forward diffusion process 630 is implemented by an image processing apparatus (such as the image processing apparatus described with reference to FIGS. 4-5) or by a training component (such as the training component described with reference to FIG. 4).

According to some aspects, reverse diffusion process 640 is applied to noisy features 635 to gradually remove the noise from noisy features 635 at the various noise levels to obtain denoised image features 645 in latent space 625. In some cases, reverse diffusion process 640 is implemented as the reverse diffusion process described with reference to FIG. 5. In some cases, reverse diffusion process 640 is implemented using a U-Net ANN included in the image generation model.

According to some aspects, a training component (such as the training component described with reference to FIG. 4) compares denoised image features 645 to original image features 620 at each of the various noise levels, and updates parameters of the image generation model or the additional image generation model based on the comparison. In some cases, image decoder 650 decodes denoised image features 645 to obtain output image 655 in pixel space 610. In some cases, an output image 655 is created at each of the various noise levels. In some cases, the training component compares output image 655 to original image 605 to train the diffusion model.

In some cases, image encoder 615 and image decoder 650 are pretrained prior to training the image generation model. In some examples, image encoder 615, image decoder 650, and the image generation model are jointly trained. In some cases, image encoder 615 and image decoder 650 are jointly fine-tuned with the image generation model.

According to some aspects, reverse diffusion process 640 is guided based on a guidance prompt such as one or more prompts 660 (e.g., a text prompt, a skeleton map or a combination thereof). In some cases, prompt 660 is encoded using encoder 665 to obtain guidance features 670 in guidance space 675. In some cases, guidance features 670 are combined with noisy features 635 at one or more layers of reverse diffusion process 640 to encourage output image 655 to include content described by prompt 660. For example, guidance features 670 can be combined with noisy features 635 using a cross-attention block within reverse diffusion process 640.

Cross-attention, also known as multi-head attention, is an extension of the attention mechanism used in some ANNs for NLP tasks. In some cases, cross-attention enables reverse diffusion process 640 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 640 to better understand the context and generate more accurate and contextually relevant outputs.

According to some aspects, image encoder 615 and image decoder 650 are omitted, and forward diffusion process 630 and reverse diffusion process 640 occur in pixel space 610. For example, in some cases, forward diffusion process 630 adds noise to original image 605 to obtain noisy images in pixel space 610, and reverse diffusion process 640 gradually removes noise from the noisy images to obtain output image 655 in pixel space 610.

In some examples, diffusion models are based on a neural network architecture known as a U-Net. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(x₂|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 7 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 8 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data. The training system then updates parameters of the model based on the comparison. For example, parameters of a U-Net may be updated using gradient descent. Time-dependent parameters of the Gaussian transitions can also be learned.

### Image Generation Process

A method for image generation is described with reference to FIG. 7. One or more aspects of the method include obtaining an input image and a skeleton map, wherein the input image depicts a first entity and a second entity, and wherein the skeleton map indicates a first pose of the first entity and a second pose of the second entity; performing, using an image generation model, a cross-attention mechanism between image features of the input image and features representing the first entity and the second entity, respectively, to obtain modified image features; and generating, using the image generation model, an output image based on the modified image features, wherein the output image depicts the first entity having the first pose and interacting with the second entity having the second pose.

Some examples of the method, apparatus, and non-transitory computer readable medium further include obtaining an inpainting mask indicating an interaction region for the first entity and the second entity, wherein the output image is generated based on the inpainting mask. In some aspects, the input image comprises an obscured interaction region between the first entity and the second entity.

Some examples of the method, apparatus, and non-transitory computer readable medium further include obtaining the input image comprises obtaining a first preliminary image depicting the first entity and a second preliminary image depicting the second entity. Some examples further include combining the first preliminary image and the second preliminary image to obtain the input image.

Some examples of the method, apparatus, and non-transitory computer readable medium further include encoding the input image to obtain the image features. Some examples further include encoding a first region of the input image surrounding the first entity to obtain the features representing the first entity. Some examples further include encoding a second region of the input image surrounding the second entity to obtain the features representing the second entity.

Some examples of the method, apparatus, and non-transitory computer readable medium further include identifying a first bounding box for the first entity and a second bounding box for the second entity, wherein the first region is based on the first bounding box and the second region is based on the second bounding box. Some examples of the method, apparatus, and non-transitory computer readable medium further include performing the cross-attention mechanism comprises computing a key vector and a value vector for each of the first entity and the second entity.

Some examples of the method, apparatus, and non-transitory computer readable medium further include generating the output image comprises obtaining a noisy image. Some examples further include performing a reverse diffusion process on the noisy image to obtain the output image. In some aspects, the image generation model is trained using a training set including a training image and a training skeleton map, wherein the training image includes a plurality of entities and an obscured interaction region, and wherein the training skeleton map includes pose information for the plurality of entities.

FIG. 7 shows an example of a method 700 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure include a method for group image editing. According to an embodiment, the image processing apparatus (such as the image processing apparatus described with reference to FIG. 4) obtains an image and a skeleton map from a user via a user interface of a user device. In some examples, the skeleton map provides a desired pose for the entity in the obtained image. In some examples, the skeleton map provides a desired interaction for the plurality of entities in the obtained image. In some examples, an additional condition such as a pose map may be provided.

In some cases, the image processing apparatus generates a noise image, a masked image, and a binary masked image as additional input to the image generation model. In some cases, the masked image and the binary masked image include an inpainted interaction region. In some cases, the masked image and the binary masked image include an inpainted occlusion region. In some cases, the masked image and the binary masked image include partially inpainting the entity. In some cases, the masked image and the binary masked image include partially inpainting the plurality of entities.

According to an embodiment, the image generation model is conditioned on each of the noise image, masked image, binary masked image, and the skeleton map via a cross-attention mechanism. In some cases, the image generation model generates an output image (e.g., an image including a plurality of entities with interaction regions depicted in the skeleton map) based on the noise image, masked image, binary masked image, and the skeleton map.

In some cases, an embedding corresponding to the entity (or each of the interacting entities) is concatenated to obtain a combined embedding. In some cases, the image generation model is conditioned on the combined embedding via cross-attention to obtain a modified feature. In some cases, the image generation model generates the output image based on the modified feature.

At operation 705, the system obtains an input image depicting an entity and a skeleton map depicting a pose of the entity. For example, the system obtains an input image and a skeleton map, where the input image depicts a first entity and a second entity, and where the skeleton map indicates a first pose of the first entity and a second pose of the second entity. In some cases, the operations of this step refer to, or may be performed by, an image processing apparatus as described with reference to FIG. 1.

For example, in some cases, the image processing apparatus receives the image and the skeleton map from a user (such as the user described with reference for FIG. 1) or by retrieval from a database (such as the database described with reference to FIG. 1) or other data source. In some cases, the image includes an entity or a plurality of entities (e.g., persons). In some cases, the skeleton map is a line drawing depicting pose information of the entity in the image. In some cases, the skeleton map is a line drawing depicting an interaction region of the plurality of entities in the image. In some cases, the skeleton map provides an interaction information for the plurality of entities in the image to be generated.

In some cases, an image encoder encodes the image to obtain an image embedding. In some cases, the image embedding is a vector representation of the image prompt in an image embedding space. For example, the image is input to a pretrained self-supervised transformer model to extract image features.

At operation 710, the system performs, using an image generation model, a cross-attention mechanism between image features of the input image and entity features representing the pose to obtain modified image features. In some examples, the system uses the image generation model to perform a cross-attention mechanism between image features of the input image and features representing the first pose and the second pose, respectively, to obtain modified image features. In some cases, the operations of this step refer to, or may be performed by, an image generation model as described with reference to FIG. 4.

In some cases, the image generation model uses the image embedding for the entity (e.g., based on the value embedding of the entity). In some cases, the image generation model generates modified image features based on the image embedding using an attention matrix and an indicator matrix via a cross-attention mechanism. In some cases, the image generation model combines the image embedding for each of the plurality of entities (e.g., by concatenating the value embedding of each of the entities). In some cases, the image generation model generates modified image features based on the combined embedding using an attention matrix and an indicator matrix via a cross-attention mechanism.

In some cases, the cross-attention mechanism provides for intra-person guidance using the attention matrix and the indicator matrix which provides for the concatenation between pose features and image features. In some cases, the cross-attention mechanism provides for inter-person guidance using the attention matrix and the indicator matrix which provides for the concatenation between pose features (e.g., features corresponding to an interaction information) and image features. Further details regarding the cross-attention mechanism have been provided with reference to FIG. 5.

At operation 715, the system generates, using the image generation model, an output image based on the modified image features, where the output image depicts the entity with the pose. For example, the image generation model is used to generate an output image based on the modified image features, where the output image depicts the first entity having the first pose and interacting with the second entity having the second pose. In some cases, the operations of this step refer to, or may be performed by, an image generation model as described with reference to FIG. 4.

In some cases, the image generation model generates the output image based on the modified image features. For example, the image generation model generates the image via a reverse diffusion process using the modified image features as described with reference to FIGS. 5-6. In some cases, the modified features are combined with noise image and masked image using a cross-attention block within reverse diffusion process to condition the reverse diffusion process. In some cases, the output image is generated using multiple iterations of the image generation model (e.g., multiple forward passes of a reverse diffusion process described with reference to FIGS. 5-6). In some cases, the image processing apparatus provides the output image, a high-resolution image to the user via the user interface.

### Training

A method for image generation is described with reference to FIGS. 8-10. One or more aspects of the method include creating a training set including a ground-truth image, a training input image, and a training skeleton map, wherein the ground-truth image includes a plurality of entities, wherein the training input image includes the plurality of entities and an obscured interaction region, and wherein the training skeleton map includes pose information for the plurality of entities; initializing an image generation model; and training, using the training set, the image generation model to generate an output image depicting an interaction between the plurality of entities based on the pose information.

Some examples of the method, apparatus, and non-transitory computer readable medium further include creating the training set comprises obscuring a portion of the ground-truth image corresponding to the obscured interaction region to obtain the training input image. Some examples of the method, apparatus, and non-transitory computer readable medium further include creating the training set comprises computing the training skeleton map based on the ground-truth image.

Some examples of the method, apparatus, and non-transitory computer readable medium further include training the image generation model comprises obtaining a noisy image. Some examples further include performing a reverse diffusion process on the noisy image. Some examples of the method, apparatus, and non-transitory computer readable medium further include training the image generation model comprises computing a diffusion loss. Some examples further include updating parameters of the image generation model based on the diffusion loss.

FIG. 8 shows an example of a method 800 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure include a method for group image editing. According to an embodiment, the image processing apparatus is configured to perform data synthesis to enable mimicking of editing needs in a real-world application of group editing. In some cases, the synthesized data (e.g., generated images) may consider the interaction region, body posture, and appearance of each of the plurality of entities. For example, the synthesized data incorporates inter-person and intra-person features of the plurality of entities.

Referring to FIG. 8, an image processing apparatus (such as the image processing apparatus described with reference to FIG. 4) trains an image generation model (such as the image generation model described with reference to FIGS. 5-6) to generate images with masked region based on a training image and a training skeleton map, where the training image depicts a plurality of entities and the corresponding interactions. Conventional image generation models are not able to produce images that can consistently perform editing for the plurality of entities in the image. For example, conventional image generation models tend to generate images that have unreasonable social dynamics, or include a misplaced entity, or include an entity with a background different from the remaining image, or an undesirable inter-person interaction.

Conventional image generation models are not able to provide images in which a user determines an interaction or a location of an entity among a plurality of entities. For example, a user may want to accurately guide the interaction of the entities in the image. The inability of the conventional methods to include such an information (e.g., as performed by the skeleton map in the present disclosure) into an output image using an image generation model may be due to lack of training data. In some cases, the training skeleton map includes multiple persons (i.e., entities) and pose information for each of the entities. For example, the pose information corresponds to an interaction between at least two of the persons (i.e., entities). In some cases, existing image generation models may have difficulty in gathering pairwise datasets, for example, collecting a large amount of before and after editing image data including a plurality of entities may be infeasible.

Accordingly, the image generation model of an embodiment of the present disclosure, is capable of generating an image with a desired interaction (e.g., an image including a plurality of entities). For example, the image generation model is configured to perform image data synthesis for generating masks to be inpainted. In some cases, because the image includes a masked portion, a large amount of before and after editing images can be generated for training an image generation model for an image generation process.

At operation 805, the system obtains a training set including a ground-truth image, a training input image, and a training skeleton map, where the ground-truth image includes a set of entities, where the training input image includes the set of entities and an obscured interaction region, and where the training skeleton map includes interaction information for the set of entities. In some cases, the operations of this step refer to, or may be performed by, a machine learning model as described with reference to FIG. 4.

For example, in some cases, the machine learning model obtains a training set that includes creating the training set based on collects the training input image and the training skeleton map for the training dataset from a database (such as the database described with reference to FIG. 1), from another data source (such as the Internet), or from a user. In some cases, the training image depicts a plurality of entities with an inter-person interaction. In some cases, the training image describes the plurality of entities and the interaction between the entities. In some cases, the training skeleton map depicts a desired interaction between the plurality of entities.

In some examples, an example training image includes a plurality of entities with a masked interaction region. In some examples, an example training skeleton map includes a desired interaction between entities. In some cases, the machine learning model retrieves the training image and training skeleton map from the database, the other data source, or the user.

At operation 810, the system initializes an image generation model. In some cases, the operations of this step refer to, or may be performed by, a machine learning model as described with reference to FIG. 4.

At operation 815, the system trains, using the training set, the image generation model to generate an output image depicting an interaction between the set of entities based on the pose information. For example, the system uses the training set to train the image generation model to generate an output image depicting an interaction between a set of entities of the training skeleton map. In some cases, the operations of this step refer to, or may be performed by, a training component as described with reference to FIG. 4.

According to some aspects, the image generation model generates an image with a desired interaction based on the training image and the training skeleton map. According to some aspects, the image generation model generates an image based on the training image (for example, using a cross-attention mechanism and a reverse diffusion process as described with reference to FIGS. 5-6). In some cases, the training component determines a loss according to a loss function based on a comparison of the ground-truth image and the training image.

A loss function refers to a function that impacts how a machine learning model is trained in a supervised learning model. For example, during each training iteration, the output of the machine learning model is compared to the known annotation information in the training data. The loss function provides a value (the “loss”) for how close the predicted annotation data is to the actual annotation data. After computing the loss, the parameters of the model are updated accordingly and a new set of predictions are made during the next iteration.

Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). In some cases, a supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples. In some cases, the training component updates image generation parameters of the image generation model based on the loss. In some cases, the training component trains the image generation model as described herein.

According to an embodiment, the training component trains the image generation model to perform data synthesis based on randomly masking portions of interaction in an input image. In some cases, the image is masked based on a coarse scale and a fine scale. The coarse scale targets the scenarios of large modification such as person insertion and removal, which requires inpainting a large region. According to an example, the training component trains the image generation model to identify different persons using labeled bounding boxes. The fine scale targets the scenarios of small modification such as interaction manipulation, which needs a more fine-grained control of masked regions. According to an example, the training skeleton map is used to control and/or specify the interaction of an entity with other entities.

In some examples, the training component trains the image generation model to complete body parts of an entity (e.g., a person). For example, in case of occlusions among the plurality of entities, removal of an entity may need body completion of the remaining entities (e.g., surrounding people). Additionally or alternatively, in case of inserting an entity, if the reference image includes a partial body, the training component trains the image generation model to complete the remaining body parts.

In some cases, the training component conditions the additional image generation model to generate an output image using a training skeleton map as guidance. In some cases, the training component updates the parameters of the image generation model based on a comparison with the ground-truth image (i.e., based on a loss function). Further details regarding the training of the image generation model and generation of the training dataset are provided with reference to FIG. 10.

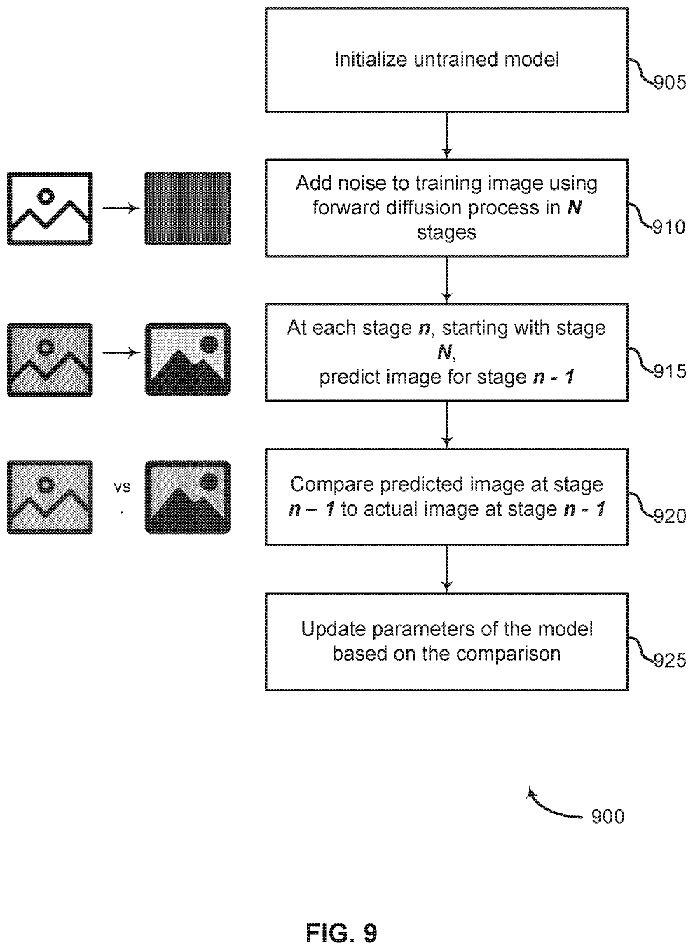

FIG. 9 shows an example of a method of training a diffusion model 900 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 9, according to some aspects, a training component (such as the training component described with reference to FIG. 4) trains a diffusion model (such as the image generation model described with reference to FIGS. 5-6) to generate an image.

At operation 905, the system initializes the diffusion model. In some cases, the operations of this step refer to, or may be performed by, a training component as described with reference to FIG. 4. In some cases, the initialization includes defining the architecture of the diffusion model and establishing initial values for parameters of the diffusion model. In some cases, the training component initializes the diffusion model to implement a U-Net architecture. In some cases, the initialization includes defining hyperparameters of the architecture of the diffusion model, such as a number of layers, a resolution and channels of each layer block, a location of skip connections, and the like.

At operation 910, the system adds noise to a training image (or an additional training image) using a forward diffusion process (such as the forward diffusion process described with reference to FIG. 6) in N stages. In some cases, the operations of this step refer to, or may be performed by, a training component as described with reference to FIG. 4.

At operation 915, at each stage n, starting with stage N, the system predicts an image for stage n−1 using a reverse diffusion process (such as a reverse diffusion process described with reference to FIG. 6). In some cases, the operations of this step refer to, or may be performed by, the diffusion model. In some cases, each stage n corresponds to a diffusion step t. In some cases, at each stage n, the diffusion model predicts noise that can be removed from an intermediate image to obtain a predicted image. In some cases, an original image is predicted at each stage of the training process.

In some cases, the reverse diffusion process is conditioned on a training prompt or other guidance (such as skeleton map as described with reference to FIGS. 1, 7, and 10). In some cases, an encoder obtains the training prompt and generates guidance features in a guidance space. In some cases, at each stage, the diffusion model predicts noise that can be removed from an intermediate image to obtain a predicted image that aligns with the guidance features.

At operation 920, the system compares the predicted image at stage n−1 to an actual image, such as the image at stage n−1 or the original input image. In some cases, the operations of this step refer to, or may be performed by, a training component as described with reference to FIG. 4. In some cases, the training component computes a loss function based on the comparison.

At operation 925, the system updates parameters of the diffusion model based on the comparison. In some cases, the operations of this step refer to, or may be performed by, a training component as described with reference to FIG. 4. In some cases, the training component updates the machine learning parameters of the diffusion model based on the loss function. For example, in some cases, the training component updates parameters of the U-Net using gradient descent. In some cases, the training component trains the U-Net to learn time-dependent parameters of the Gaussian transitions. In some cases, the training component optimizes for a negative log likelihood.

FIG. 10 shows an example of a method for training data generation 1000 according to aspects of the present disclosure. In one aspect, method for training data generation 1000 includes image 1005, first masked image 1010, second masked image 1015, and third masked image 1020. First masked image 1010, second masked image 1015, and third masked image 1020 are examples of, or includes aspects of, the corresponding element described with reference to FIG. 5.

Referring to FIG. 10, each of the masked image (i.e., first masked image 1010, second masked image 1015, and third masked image 1020) is an example of an image generated based on inpainting a portion of image 1005 by an image generation model (such as the image generation model described with reference to FIGS. 5-6) conditioned based on a process described with reference to FIGS. 8-9. In the example of FIG. 10, each of the masked image (i.e., first masked image 1010, second masked image 1015, and third masked image 1020) is generated based on a training skeleton map. For example, each of the masked image (i.e., first masked image 1010, second masked image 1015, and third masked image 1020) includes an inpainted region for an entity interaction (such as a hand or arm position), a body completion, or a combination thereof.

Embodiments of the present disclosure include an image generation model that is configured to generate diverse interactions under different conditions. In some cases, a hierarchical mechanism is used for synthesizing a dataset based on randomly masking the corresponding regions in the group portraits. In some cases, the coarse scale targets the scenarios of large modification such as entity (e.g., person) insertion and removal, which requires inpainting a large region.

Referring to FIG. 10, third masked image 1020 depicts an example of a coarse level training data generation process for person interaction. In some cases, the fine scale targets the scenarios of small modification such as interaction manipulation, which needs a more fine-grained control of masked regions. As shown in FIG. 10, first masked image 1010 depicts an example of a fine level training data generation for person interaction.

An embodiment of the disclosure includes a coarse scale data synthesis, wherein the image generation model identifies entities (e.g., persons) through labeled bounding boxes. In some cases, the interaction regions are assumed near the boundary of each bonding box. In some cases, single or multiple bounding boxes are randomly selected during training and the region near the boundary is masked.

According to an embodiment, the coordinate of the top-left point of the bounding box is (x₁,y₁) and the right-bottom point is (x₂,y₂). The width of the bounding box is w=x₂−x₁. The left boundary region of the bounding box can be denoted as the rectangle with (x₁−r·w,y₁) as the top-left corner and (x₁+r·w,y₂) as the right-bottom corner. Similarly, the right boundary of the bounding box is obtained. In some cases, the boundary regions can be considered as the interaction regions.

An embodiment of the disclosure includes randomly mask the left boundary, the right boundary, or left and right boundaries. In some cases, the value of r from [0.1,0.2]. Third masked image 1020 depicts masking each of the left and right boundary regions. In some cases, the mask is extended outside the bounding box to cover the entire column of the boundary region (such as the second image of the third masked image 1020). In some cases, the top-left coordinate is set as (x₁−r·w,0) and the right-bottom coordinate is set as (x₁+r·w,h), where h is the height of the image. According to an example, human parsing is used to unmask the facial regions (i.e., to prevent facial regions from being masked). Additionally or alternatively, the shape of the mask is augmented to resemble a brush to match a user input.

An embodiment of the disclosure includes a fine scale data synthesis, wherein a skeleton map is used to control the person interaction. For example, a person interaction refers to the hand and arm positions. In some examples, the using the skeleton map with the image generation model according to aspects of the present disclosure enables users to specify the desired human interaction better than a conventional image generation model. The accuracy of the skeleton map ensures the quality of data generation (such as a quality of the output image). In some cases, an open-source pose estimation tool is used for skeleton detection or extraction.

Conventional skeleton extraction methods segment out the arm and hand regions with a tight bounding box to generate the mask. However, the mask shape in such methods leaks the skeleton information. As an example in FIG. 10, in case of first masked image 1010, the first image of the first masked image 1010 is obtained based on a tight bounding box (i.e., by strictly following the skeleton map). That is, the model may overlook the skeleton condition during training because the masked image leaks the skeleton information, which makes customization of the output interaction regions difficult (e.g., at inference time) using the skeleton map.

An embodiment of the present disclosure includes a data augmentation mechanism. As an example, the data augmentation mechanism refers to random rotation of the arms or hands in a different direction. By using a data augmentation mechanism as disclosed herein, embodiments of the present disclosure provide an augmented masked image that prevents a leakage of skeleton information.

Referring again to FIG. 10, the right arm of an entity (e.g., a woman) in the first image of the first masked image 1010 is randomly rotated to obtain an augmented masked image (e.g., second image of the first masked image 1010). Accordingly, the augmented masked image is obtained based on a broad bounding box (i.e., by loosely following the skeleton map). In some examples, each arm region (i.e., left arm and right arm regions) may be masked based on the skeleton map and an augmented skeleton.

An embodiment of the present disclosure includes an image generation model configured to complete a body part of an entity. In some cases, when there are occlusions among different persons, removal of an entity (e.g., a person) needs the body completion of the other entities (e.g., surrounding people). Additionally or alternatively, when inserting an entity into an image, if the reference image contains a partial body, the image generation model performs body completion. For example, the image generation model completes the remaining body parts of the entity.

Referring to FIG. 10, the image generation model randomly masks the lower body parts (as shown in second masked image 1015). The top-left point of the bounding box is represented as (x₁,y₁) and the right-bottom point of the bounding box is represented as (x₂,y₂). In some cases, the image generation model randomly masks the region from (x₁,y₁+r·(y₂−y₁) to (x₂,y₂), where r is sampled from [0.5, 0.9].

FIG. 11 shows an example of a method 1100 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Embodiments of the present disclosure include a method for group photo editing. The image processing apparatus of the present disclosure is configured to perform data synthesis to mimic editing needs in a real-world application. In some cases, the synthesized data (e.g., generated images) may take into account the body posture and appearance of the entity in the input image. For example, the synthesized data incorporates intra-person features of the entity. Referring to FIG. 11, an image processing apparatus (such as the image processing apparatus described with reference to FIG. 4) trains an image generation model (such as the image generation model described with reference to FIGS. 5-6) to generate images with masked region based on a training image and a training skeleton map, where the training image depicts an entity with a pose.

Conventional image generation models are not able to consistently produce images that can edit an entity with a pose in the image. For example, conventional image generation models generate images with unreasonable poses, or include a misplaced entity, etc. Conventional image generation models are not able to provide images in which a user determines a pose of an entity. For example, a user may want to accurately guide the hand position (or position of any other body part) of an entity. Additionally, the lack of training data results in the inability of the conventional methods to incorporate user provided guidance or information (e.g., as performed by the skeleton map in the present disclosure) into an output image.

By contrast, embodiments of the present disclosure are capable of generating an image with a desired pose information (e.g., an image including an entity). For example, the image generation model is configured to perform image data synthesis for generating masks to be inpainted. In some cases, because the image includes a masked portion, a large amount of before and after editing images can be generated for training an image generation model for an image generation process.

At operation 1105, the system obtains a training set including a ground-truth image, a training input image, and a training skeleton map, where the ground-truth image includes an entity with a pose. Additionally, the training input image includes the entity and an obscured interaction region, and the training skeleton map indicates the pose of the entity. In some cases, the training skeleton map includes an entity and pose information for the entity. In some cases, the operations of this step refer to, or may be performed by, a machine learning model as described with reference to FIGS. 4 and 8.

For example, in some cases, the machine learning model obtains a training set that includes creating the training set based on collecting the training input image and the training skeleton map for the training dataset from a database (such as the database described with reference to FIG. 1), from another data source (such as the Internet), or from a user. In some cases, the training image depicts an entity with a pose. In some cases, the training image describes the entity. In some cases, the training skeleton map depicts a pose of the entity. In some cases, the machine learning model retrieves the training image and training skeleton map from the database, the other data source, or the user.

At operation 1110, the system trains, using the training set, the image generation model to generate an output image depicting the entity with the pose information. For example, the system uses the training set to train the image generation model to generate an output image depicting an entity with a pose of the training skeleton map. In some cases, the operations of this step refer to, or may be performed by, a training component as described with reference to FIGS. 4 and 8.

According to some aspects, the image generation model generates an image with a desired pose information based on the training image and the training skeleton map. According to some aspects, the image generation model generates an image based on the training image (for example, using a cross-attention mechanism and a reverse diffusion process as described with reference to FIGS. 5-6). In some cases, the training component determines a loss according to a loss function based on a comparison of the ground-truth image and the training image (as described with reference to FIG. 8).

According to an embodiment, the training component trains the image generation model to perform data synthesis based on randomly masking portions with pose information in an input image. In some cases, the image is masked based on a coarse scale and a fine scale. The coarse scale targets the scenarios of large modification such as person insertion and removal, which requires inpainting a large region. According to an example, the training component trains the image generation model to identify a person using labeled bounding boxes. The fine scale targets the scenarios of small modification such as pose information, which needs a more fine-grained control of masked regions. According to an example, the training skeleton map is used to control and/or specify the entity pose information, such as (but not limited to) hand and arm positions.

In some cases, the training component conditions the additional image generation model to generate an output image using a training skeleton map as guidance. In some cases, the training component updates the parameters of the image generation model based on a comparison with the ground-truth image (i.e., based on a loss function). Additional details regarding the training of the image generation model and generation of the training dataset are provided with reference to FIGS. 8 and 10.

One or more example embodiments of the present disclosure may be implemented using a machine learning framework. In some examples, the image generation model is trained using a high-performance computing accelerator. An adaptive learning rate optimization algorithm is used to optimize the model. The beta is set as the default value. In an example, the learning rate is set as 10⁻⁴. For example, the learning rate schedular is LambdaLinearScheduler. For example, the number of warm-up steps is set as 2500. For example, the batch size is set as 4 per 412 GPU, and the global batch size is 32. The model is initialized with the Stable-Diffusion Inpainting model. In some examples, the Stable Diffusion Inpainting model has 9 channels as input. In some examples, the skeleton map is concatenated as an additional input, and thus the number of channels is 12. For example, for the first 9 channels of the first layer, the weights of Stable Diffusion Inpainting model are used and the remaining three channels are initialized with zero weights. In an example, the model is trained for 80 epochs.

According to an exemplary embodiment, the resolution of the image used for training is 512×512. In some cases, a multi-human parsing dataset, which is composed of 25, 403 group photo images, is used. Each image includes human parsing annotations. The annotations provided in the dataset are used directly for human parsing. In some examples, a package that provides various pose estimation methods is used to predict the skeleton.

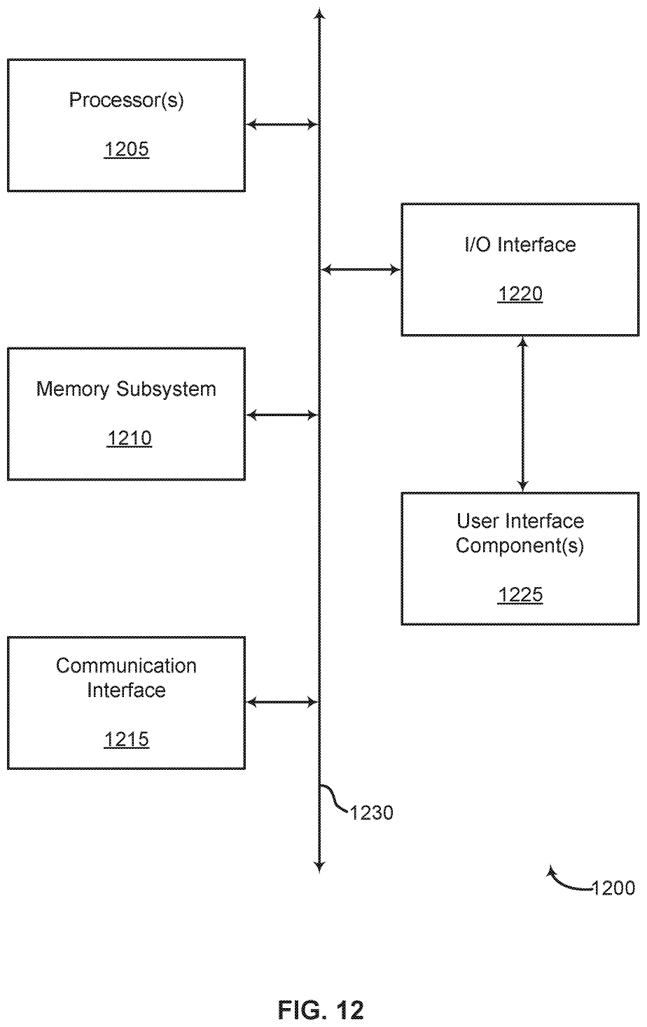

FIG. 12 shows an example of a computing device 1200 according to aspects of the present disclosure. According to some aspects, computing device 1200 includes processor 1205, memory subsystem 1210, communication interface 1215, I/O interface 1220, user interface component 1225, and channel 1230.

In some embodiments, computing device 1200 is an example of, or includes aspects of, the image processing apparatus described with reference to FIG. 4. In some embodiments, computing device 1200 includes one or more processors 1205 that can execute instructions stored in memory subsystem 1210 to obtain an input image and a skeleton map, wherein the input image depicts a first entity and a second entity, and wherein the skeleton map indicates a first pose of the first entity and a second pose of the second entity; perform, using an image generation model, a cross-attention mechanism between image features of the input image and entity features representing the pose to obtain modified image features; and generate, using the image generation model, an output image based on the modified image features, wherein the output image depicts the first entity having the first pose and interacting with the second entity having the second pose.

According to some aspects, computing device 1200 includes one or more processors 1205. Processor(s) 1205 are an example of, or includes aspects of, the processor unit as described with reference to FIG. 4. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1210 includes one or more memory devices. Memory subsystem 1210 is an example of, or includes aspects of, the memory unit as described with reference to FIG. 4. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote-control device interfaced with a user interface directly or through the I/O controller), or a combination thereof. In some cases, user interface component(s) 1225 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation, comprising:
obtaining an input image depicting an entity and a skeleton map depicting a pose of the entity;
performing, using an image generation model, a cross-attention mechanism between image features of the input image and entity features representing the pose to obtain modified image features; and
generating, using the image generation model, an output image based on the modified image features, wherein the output image depicts the entity with the pose.

2. The method of claim 1, further comprising:
obtaining an inpainting mask indicating an interaction region of the entity with an additional entity, wherein the output image is generated based on the inpainting mask.

3. The method of claim 1, wherein:
the input image comprises an obscured interaction region between the entity and an additional entity.

4. The method of claim 1, wherein obtaining the input image comprises:
obtaining a first preliminary image depicting the entity and a second preliminary image depicting an additional entity; and
combining the first preliminary image and the second preliminary image to obtain the input image.

5. The method of claim 1, further comprising:
encoding the input image to obtain the image features; and
encoding a first region of the input image surrounding the entity to obtain the entity features.

6. The method of claim 5, further comprising:
identifying a first bounding box for the entity and a second bounding box for an additional entity, wherein the first region is based on the first bounding box.

7. The method of claim 1, wherein performing the cross-attention mechanism comprises:
computing a key vector and a value vector for the entity.

8. The method of claim 1, wherein generating the output image comprises:
obtaining a noisy image; and
performing a diffusion process on the noisy image to obtain the output image.

9. The method of claim 1, wherein:
the image generation model is trained using a training set including a training image and a training skeleton map, wherein the training image includes a plurality of entities and an obscured interaction region between the plurality of entities, and wherein the training skeleton map includes pose information for the plurality of entities.

10. A method of training an image generation model, the method comprising:
obtaining a training set including a ground-truth image, a training input image, and a training skeleton map, wherein the ground-truth image includes an entity with a pose, the training input image includes the entity and an obscured interaction region, and the training skeleton map indicates the pose of the entity; and
training, using the training set, the image generation model to generate an output image depicting the entity with the pose.

11. The method of claim 10, wherein obtaining the training set comprises:
obscuring a portion of the ground-truth image corresponding to the obscured interaction region to obtain the training input image.

12. The method of claim 10, wherein obtaining the training set comprises:
computing the training skeleton map based on the ground-truth image.

13. The method of claim 10, wherein training the image generation model comprises:
obtaining a noisy image; and
performing a reverse diffusion process on the noisy image.

14. The method of claim 10, wherein training the image generation model comprises:
computing a diffusion loss; and
updating parameters of the image generation model based on the diffusion loss.

15. An apparatus for image generation, comprising:
at least one processor;
at least one memory component coupled with the at least one processor; and
an image generation model comprising parameters stored in the at least one memory component and trained to receive an input image and pose information for a plurality of entities in the input image and to generate an output image depicting an interaction between the plurality of entities based on the pose information.

16. The apparatus of claim 15, wherein:
the image generation model comprises a boundary component configured to identify a bounding box for each of the entities.

17. The apparatus of claim 15, wherein:
the image generation model comprises a cross-attention layer configured to perform a cross-attention mechanism between image features of the input image and features representing the plurality of entities to obtain modified image features.

18. The apparatus of claim 17, wherein:
the cross-attention layer is configured to compute a key vector and a value vector for each of the plurality of entities.

19. The apparatus of claim 15, wherein:
the image generation model comprises a diffusion model.

20. The apparatus of claim 15, wherein:
the image generation model comprises a U-net architecture.
